(19) United States
(12) Patent Application Publication
(10) Pub. No.: US 2024/0300140 A1
(43) Pub. Date: Sep. 12, 2024

(54) DEVICE FOR APPLYING CLAY TO A SURFACE

(71) Applicant: STAEDTLER MARS GMBH & CO. KG, Nürnberg (DE)

(72) Inventors: Udo TARTLER, Lützelbach (DE); Arthur PRIOR, London (GB); Judith SCHWEMMER, Happurg (DE)

(21) Appl. No.: 18/562,042

(22) PCT Filed: May 18, 2022
(86) PCT No.: PCT/EP2022/063408

§ 371 Date: May 30, 2024

(30) Foreign Application Priority Data
May 18, 2021 (DE) 10 2021 112 854.4

(51) Int. Cl. B28B 3/26; B28C 5/08

(52) U.S. Cl. CPC B28B 3/2609; B28C 5/0893

(57) ABSTRACT

A device for applying clay to a surface, in particular for producing models, including a housing with a connection piece for a clay supply hose and with a clay dispensing opening. A disk, which is rotatably seated in a clay dispensing flange opening in a clay-tight manner and is driven by a motor, has the dispensing opening and otherwise closes off the flange opening, and has an elevated portion on its exterior.

The present invention relates to a device for applying clay to a surface, in particular for producing models, having a housing with a connecting port for a clay supply hose and a clay dispensing opening.

Clay is a material which is used in particular for building models in the field of automotive design. However, character designers, for example for films, cartoons and video games, industrial designers, artists and architects also use this material for modelling their three-dimensional creations. Clay is a special refinement, developed for this purpose, of the well-known plasticine.

Clay is a compound which is usually wax-based and is plastically deformable at specific temperatures. In most of the variants, sulfur is used as a filler. Clay has in most instances a brownish or grey color which readily enables the visibility of a modelled shape, in particular in order for the latter to be checked by the designer when modelling.

For example, prior to a new automobile being launched in the market, the design process of the new body of this automobile is lengthy and complex: sketches, drawings and 3D-CAD are first used. However, even nowadays, models of the vehicle are finally built, usually in various scales ranging from 1:10 and 1:4 to 1:1. It is only then that the shapes and proportions can really be effectively evaluated as a whole and in detail. Moreover, the shapes and proportions of the clay model can also be reworked and finished precisely and in detail. This is because clay can be, for example, milled, planed, carved or sanded at room temperature, while being dimensionally stable. However, a subsequent application of material is also possible, whereby the clay is heated in the region of the envisaged material application by means of a hot air blower or a radiator (to temperatures not beyond the two-digit temperature range in Celsius), for example. Clay can be plastically deformed in this upper critical temperature range of in particular approximately 60 to 70° C., and forms a substantially homogenous connection with a clay material which is at roughly the same warm temperature and is additionally applied. Once cooled, the location supplemented by the application is dimensionally stable again and has a substantially homogenous point of transition when carefully worked, and can also be subtractively machined again there. Clay can also be painted, or covered with colored film, by means of known method steps. Overall, a model which in terms of design and surface matches the planned product extremely closely, or is even identical to the latter, can be produced from clay in this way.

In order to produce such a model, a timber frame or metal frame is usually made first, to which are fastened boards (for example foam boards), for instance made of polyurethane, so as to apply thereto clay as an external modelling-capable outer layer of the model as described—this usually being done in layers in order to generate a desired clay layer thickness—and to thus form a preliminary model, the entirety of which is ideally at least of the size of the final model.

This application is still widely performed manually. The warmed clay (below 60° C.) is usually applied using kneading hand movements and worked by means of spatula-type tools and blades-specifically in the mentioned temperature range of the clay, in which the latter can be plastically deformed and thus readily adheres to the frame boards. There are various known measures for improving adhesion such as, for example, applying a sealing coat (for example by brush or spray), in particular also for binding dust, and/or forming depressions and/or barb structures, for instance by drilling, or by machining grooves, in which the clay can additionally be held in a form-fitting manner for adhesion purposes.

During and after this application, the targeted surface design of the clay can also already be produced by plastic shaping, or at least be prepared by corresponding preliminary shaping and contouring, at least in regions, as long as the clay has not fully cooled.

However, mechanical devices and methods are also known, for example from DE 10 2016 109 816. When mechanically processing by means of such a device, difficulties arise in the prior art, specifically in terms of the inherent connection between the clay from the supply line and an already applied layer, or else in terms of the homogeneity of the plasticized clay when exiting the supply line, where there is a consistency in the peripheral region of the exiting clay that deviates from the consistency in the center of the strand.

The present invention is based on the object of achieving a device for mechanically applying clay, in particular for producing models, which simplifies and accelerates building models while using clay as a molding compound.

A device according to the invention serves to apply clay to a surface, in particular for producing preliminary models, as has been described at the outset. The device has a housing with a connecting port for a clay supply line, for example a flexible (optionally heated) high-pressure hose, so as to enable movements of the device across the surface, for example by hand, or else by means of a robotic arm or a CNC system, in an ideally free manner. The housing also has a clay dispensing opening.

According to the invention the device has a disk which sits in a clay-tight manner in a clay dispensing flange opening, specifically so as to be rotatable and driven by a motor. The disk herein closes off this flange opening but has the (at least one) dispensing opening through which the clay supplied to the device can exit. The disk also has at least one elevation on the external side.

The elevation is a massaging bead, so to speak, i.e. a “wobbler”, which on account of its circular movements serves to massage the clay onto the surface (and into the surface)—specifically when the surface is already composed of clay, in particular, for instance because a layer of clay has already been applied.

To this end, it is particularly preferable that (in any combination or individually or with all) the (at least one) elevation (in the case of a plurality of elevations, all or at least one of the elevations—also different ones of the elevations with different ones of the features)
is disposed eccentrically on the disk; and/or
extends along the radial periphery of the disk; and/or
conjointly with a region of the external side or the entire external side of the disk, forms a consistent surface; and/or
has an edge which also extends radially.

To this end, it is also particularly preferable that the (at least one) dispensing opening in the disk
is an elongate bore which extends in the shape of a circular segment and concentrically in the disk; and/or
a plurality of dispensing openings are distributed uniformly on a circumference about the rotation axis of the disk.

It is also particularly preferable for the peripheral region of the clay dispensing flange opening to be designed by means of sleeves (at least one) that match in a form-fitting manner, which can be removed and replaced again and in this way reposition the opening periphery toward the front, axially further out of the housing, by the length of the respective sleeve (and in this way allow the wobbler or at least the disk to disappear deeper into the opening), or reposition said opening periphery into the housing, axially toward the rear (and in this way allow the disk or at least the wobbler to protrude farther from the opening).

A mixer and/or propeller or impeller (in particular two impellers, preferably having blades inclined in opposite directions—or even a plurality of impellers—in particular axially spaced apart from one another) can also be disposed in the device, in particular in the region of the dispensing line, so as to in particular additionally homogenize and mix the clay. These can likewise be rotationally driven by the motor. To this end, the impellers in this instance preferably sit on a drive shaft, conjointly with the dispensing opening propeller according to the invention.

Alternatively however, the impellers and their mounting can also be designed in such a way that the impellers are not actively driven by the drive, but are either held on the tubular wall, thus serving as stationary impellers, or are mounted so as to freely rotate on the shaft, for example in a “floating” manner with a through bore, so that said impellers, depending on the inclination of their blades, are driven in a rotating direction by the clay flowing through, and in this way additionally homogenize and mix the clay. The same applies in an analogous manner to the mixer.

Further advantages, design embodiments and details of the invention will be described in the description of exemplary embodiments hereunder with reference to the appended figures, in which:

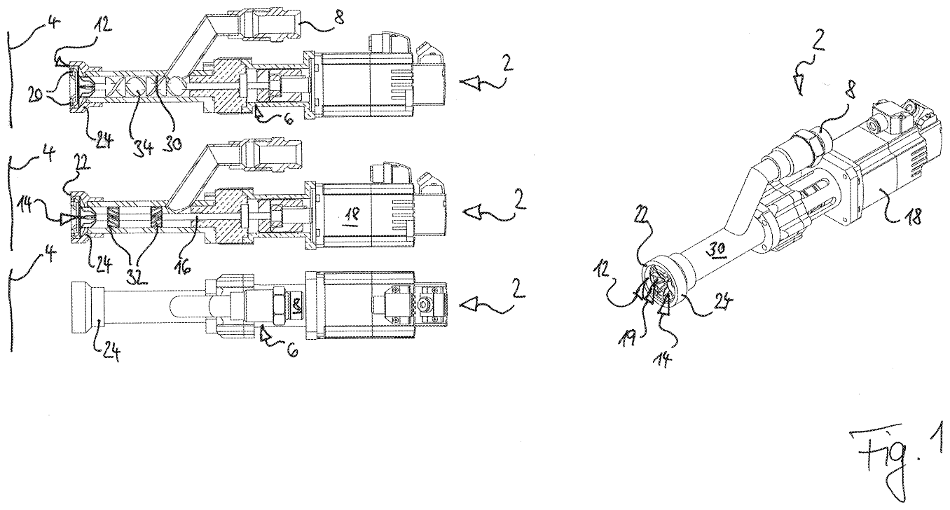

FIG. 1 shows four views of a device according to the invention, specifically two alternative longitudinal sections, one with a mixer and one with two impellers which are axially spaced apart from one another and rotationally driven on the motor shaft, and therebelow a view from above, and an isometric view on the right thereof;

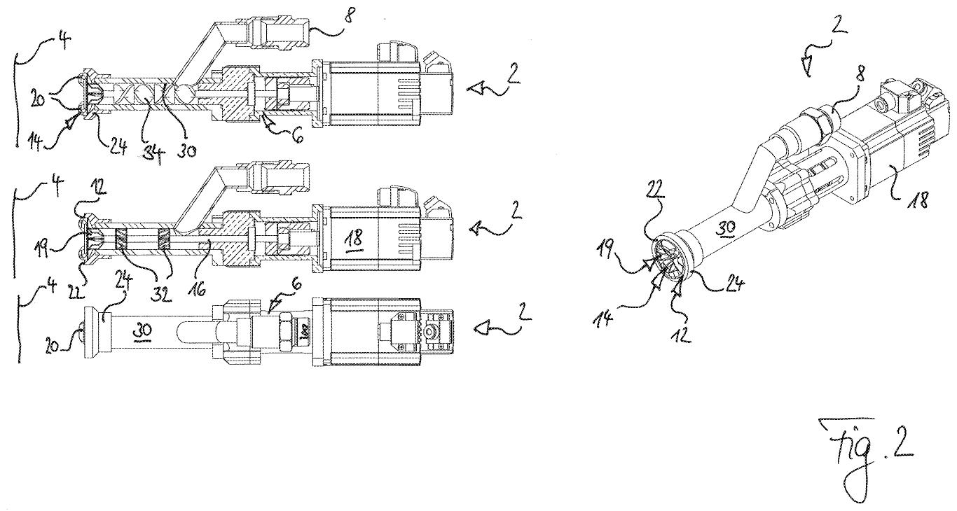

FIG. 2 shows the views of the device according to the invention from FIG. 1, with an alternative sleeve on the clay dispensing flange opening;

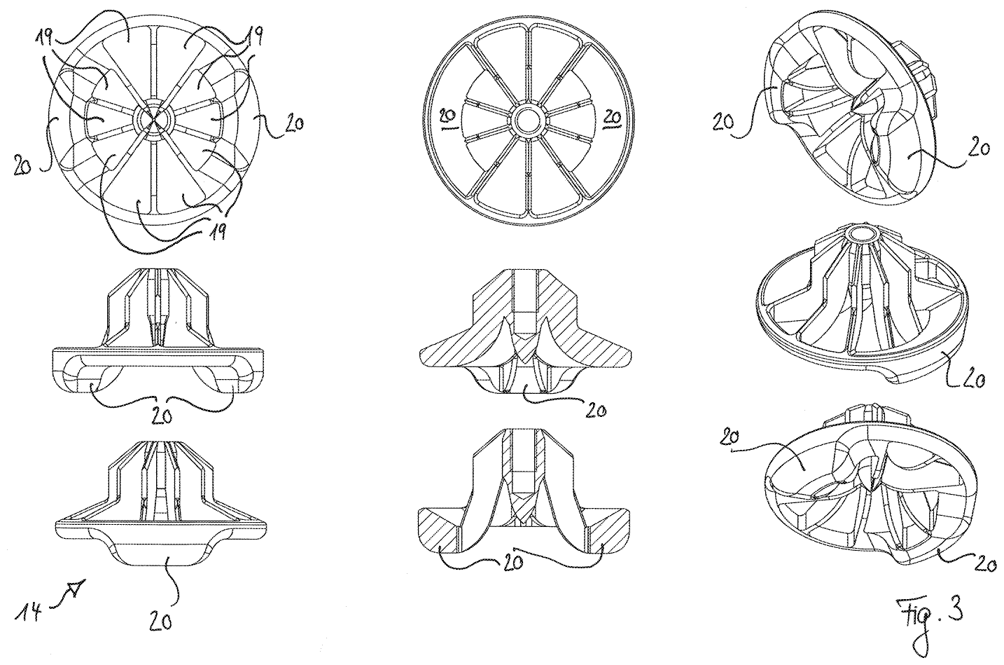

FIG. 3 shows nine views of the wobbler disk 14 according to the invention from FIGS. 1 and 2;

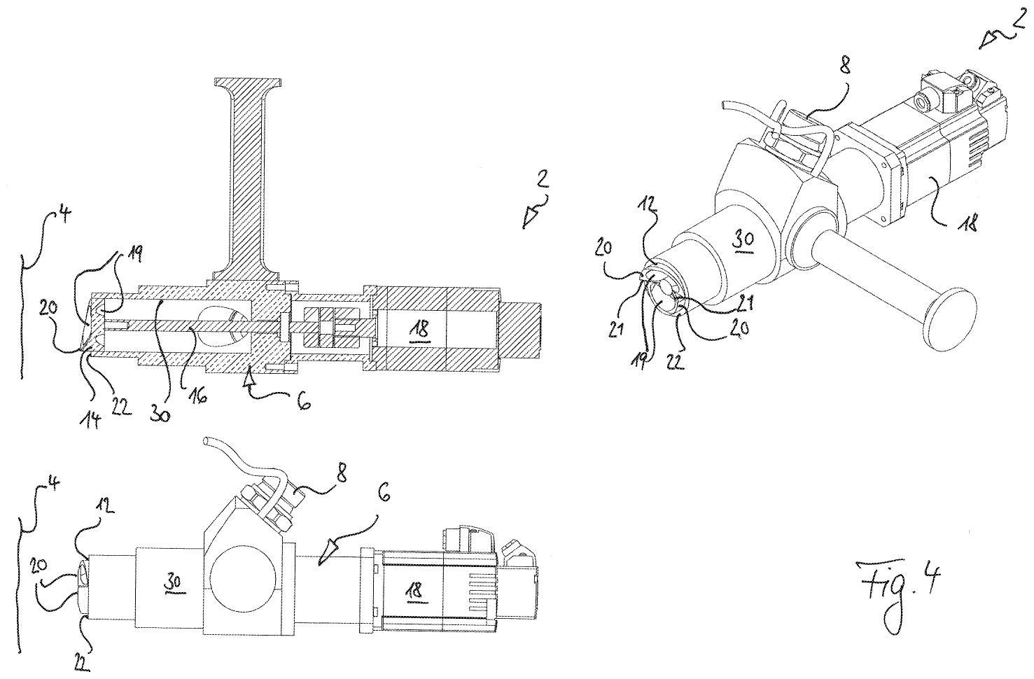

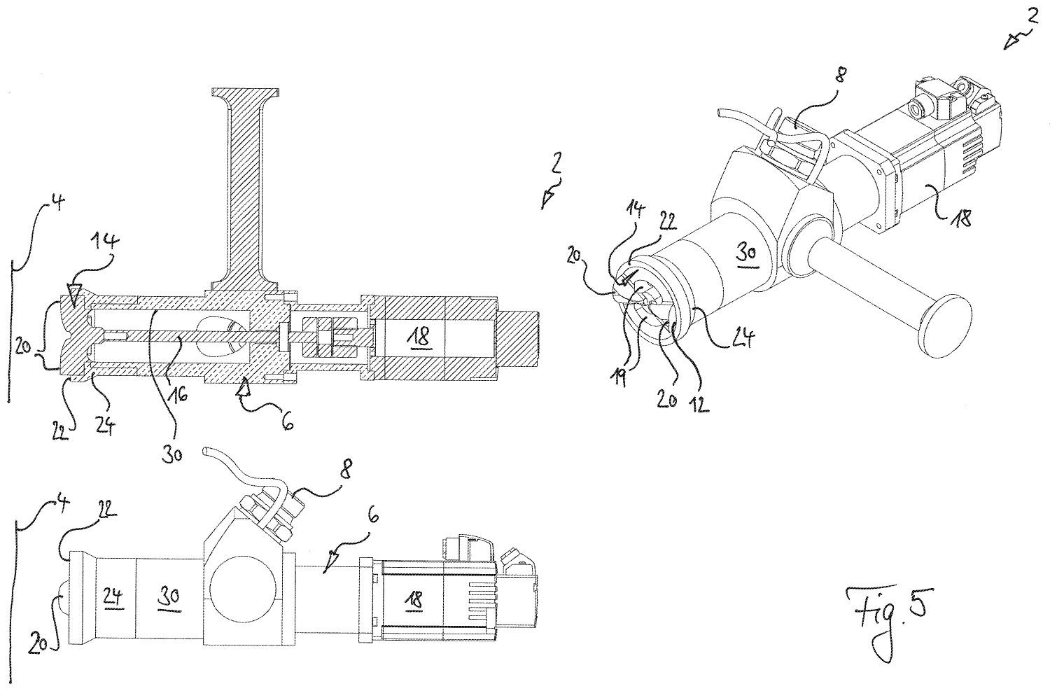

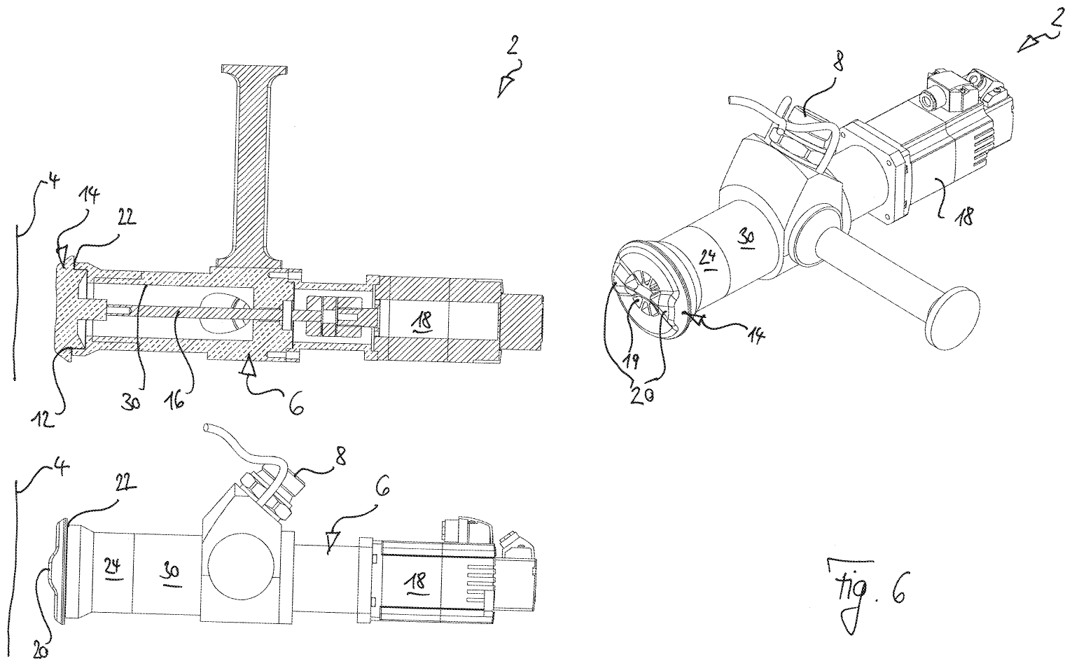

FIGS. 4 to 6 show three views of a device according to the invention, specifically a longitudinal section, and therebelow a lateral view; and on the right an isometric view, in each case having differently configured clay dispensing flange openings and different wobbler disks; and

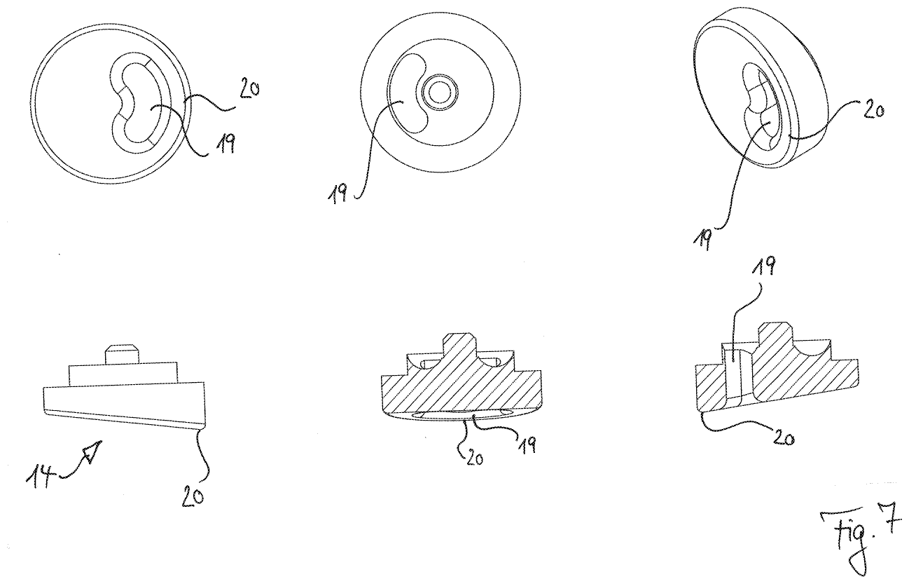

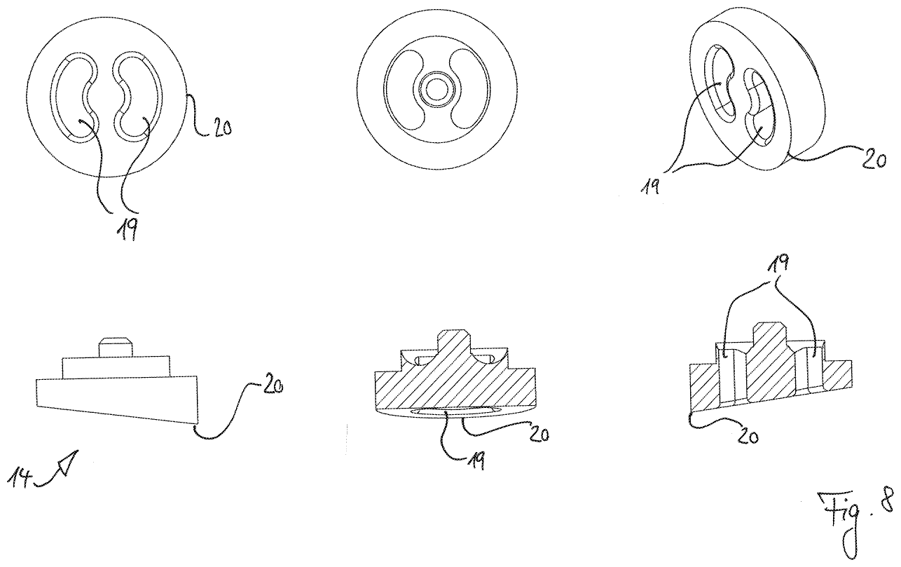

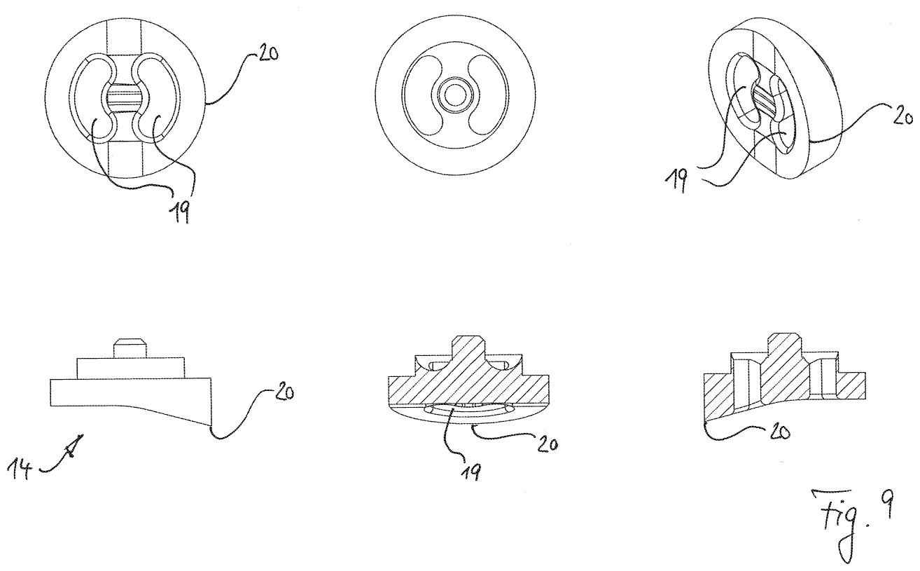

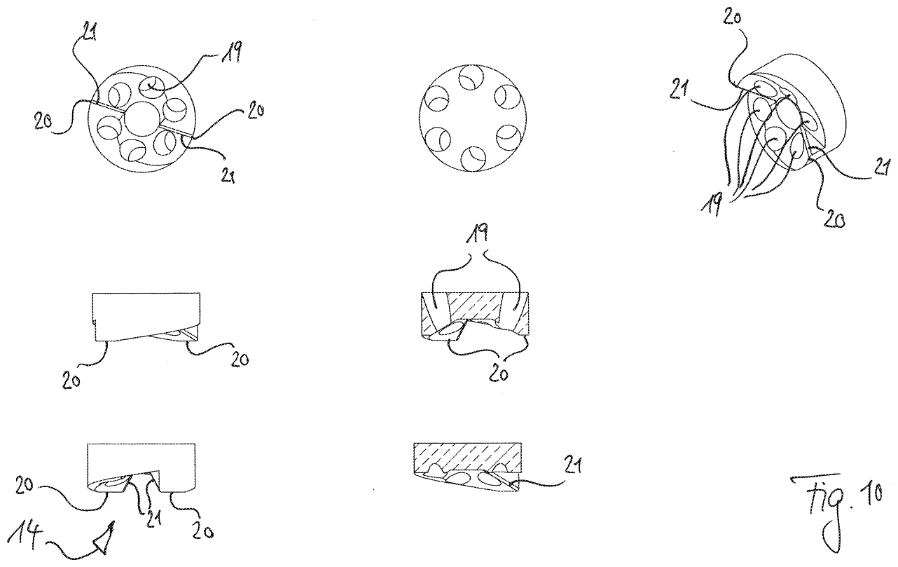

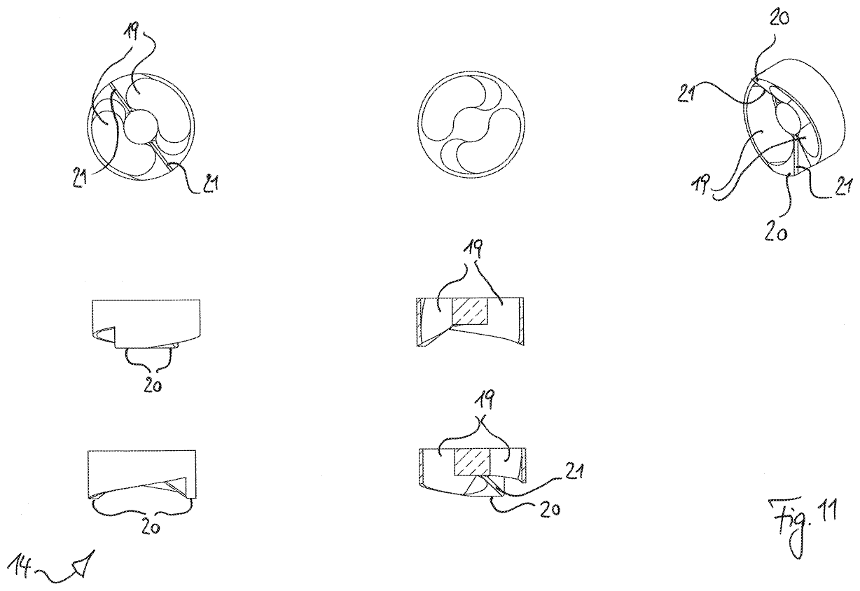

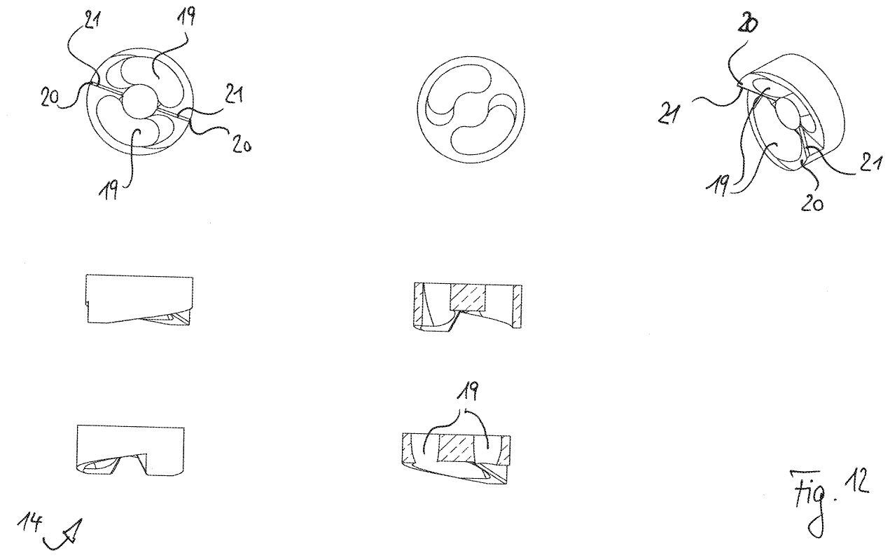

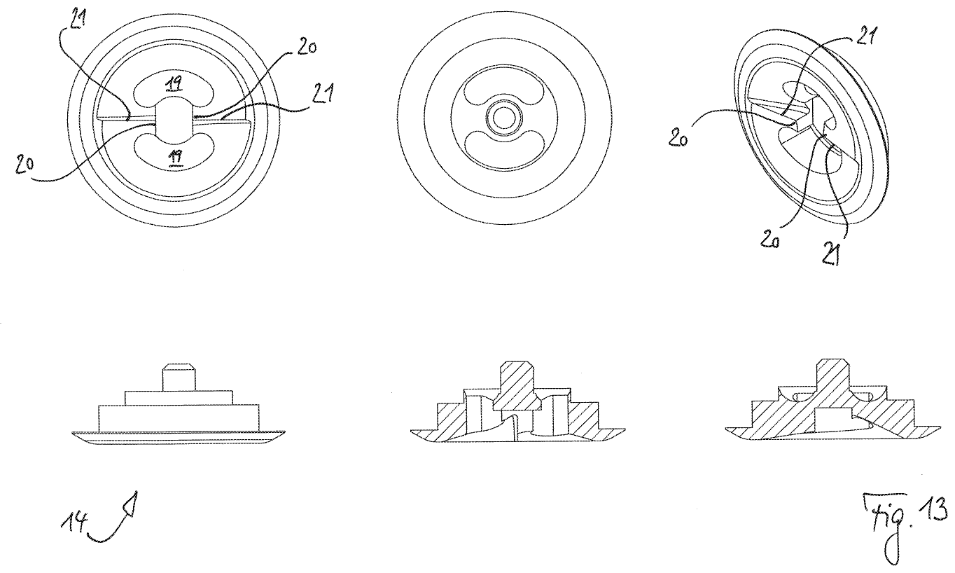

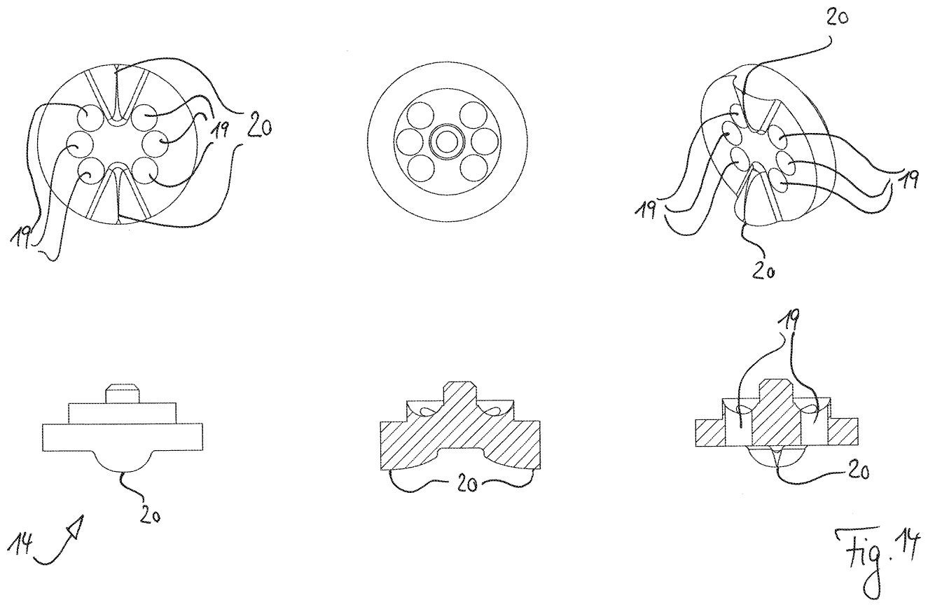

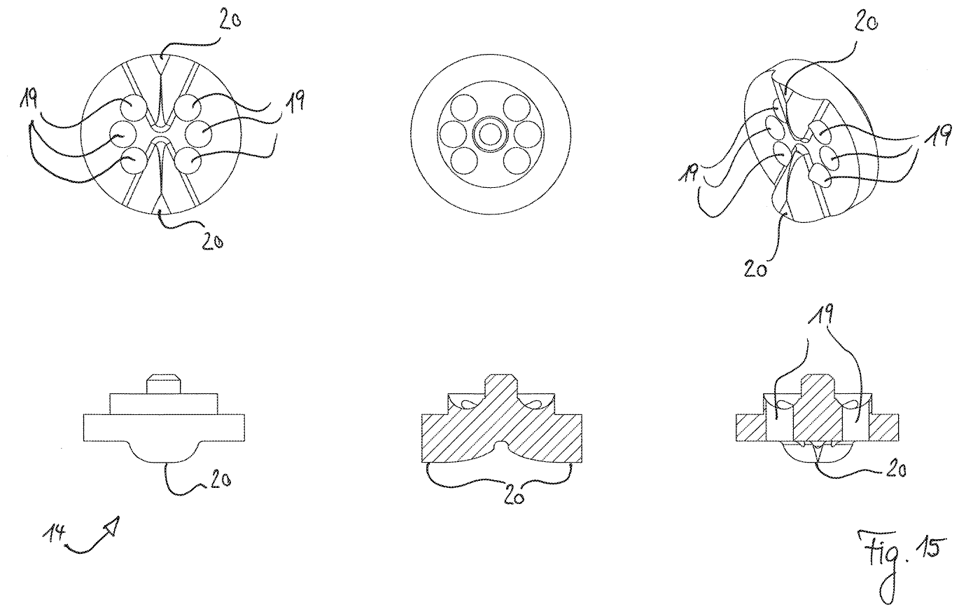

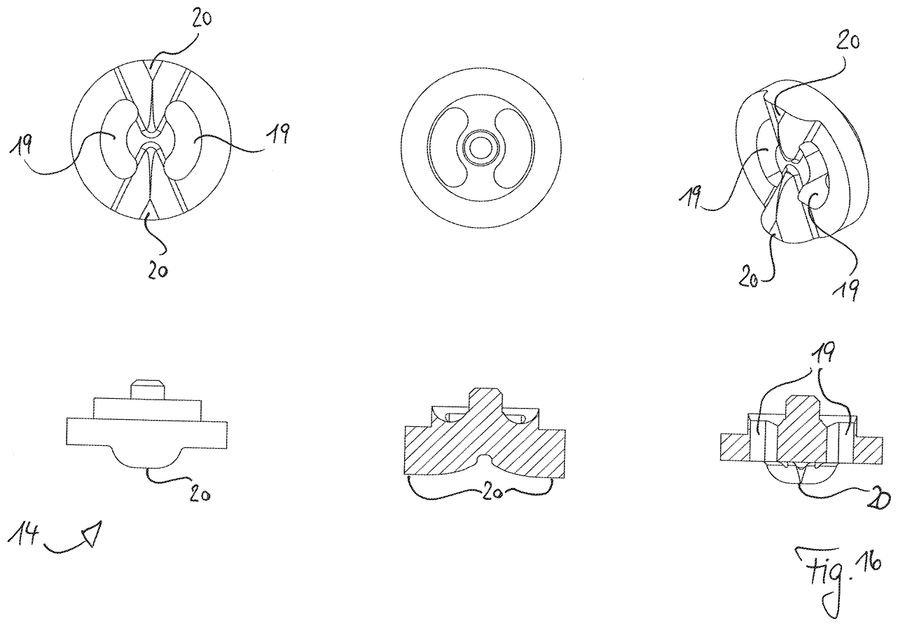

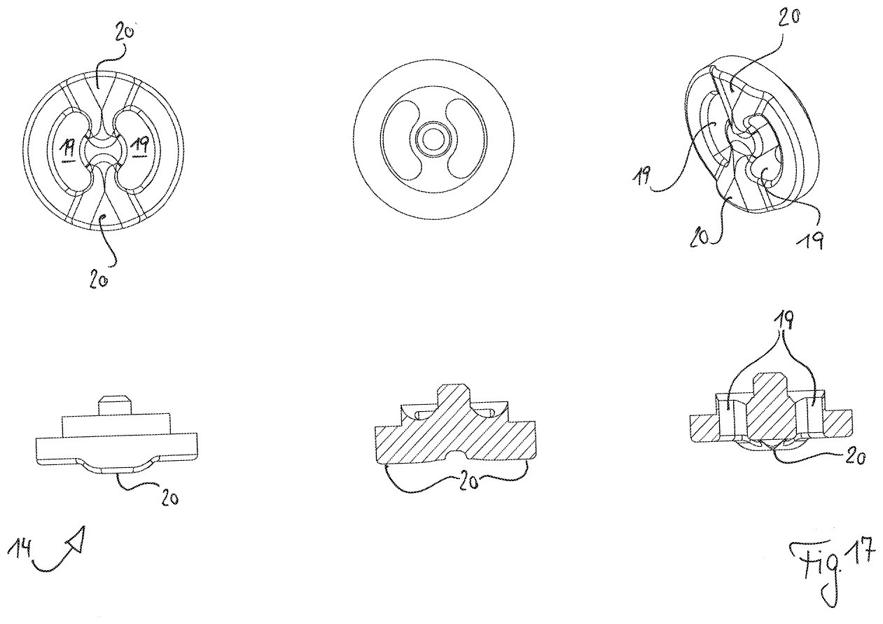

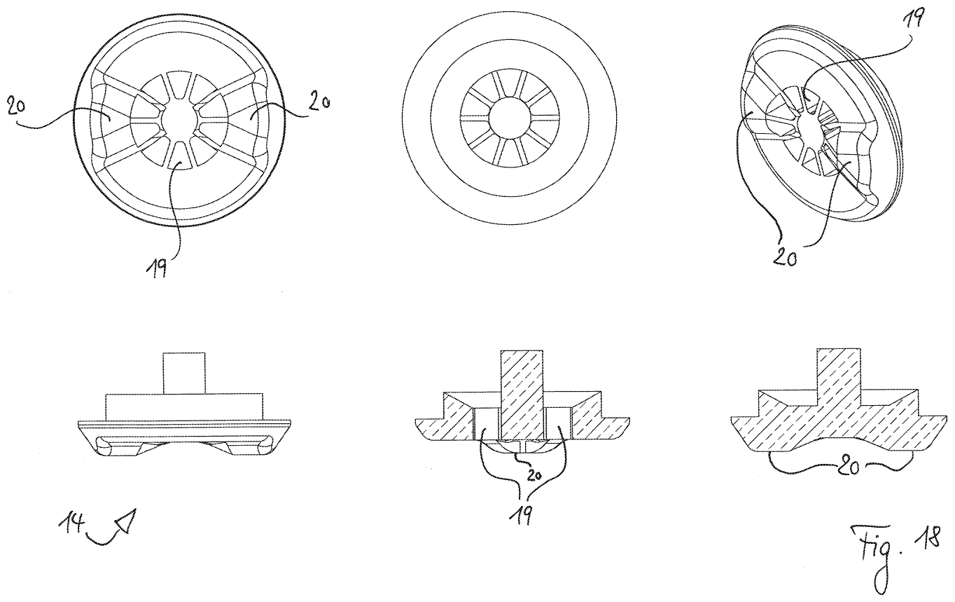

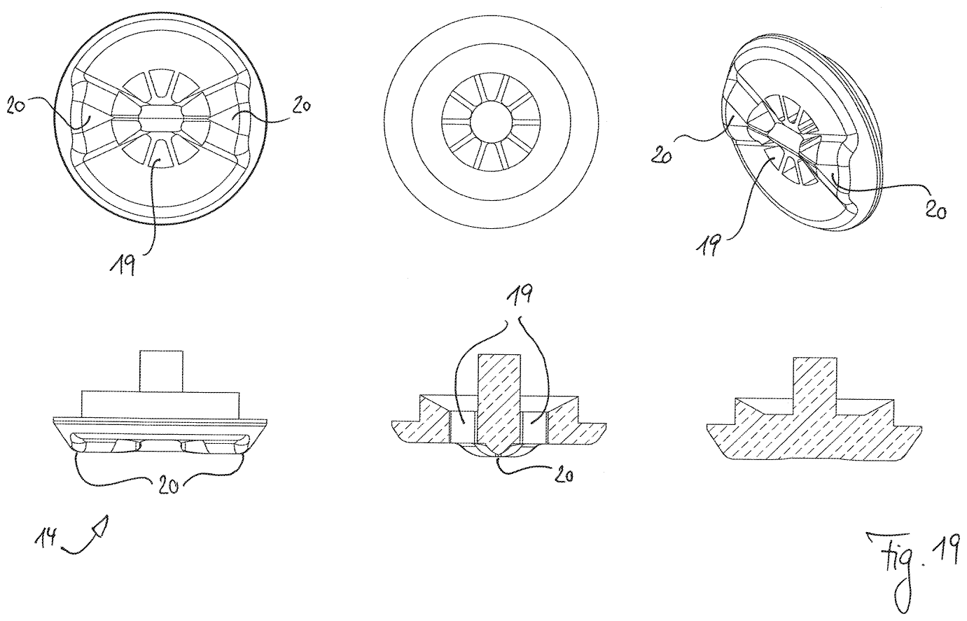

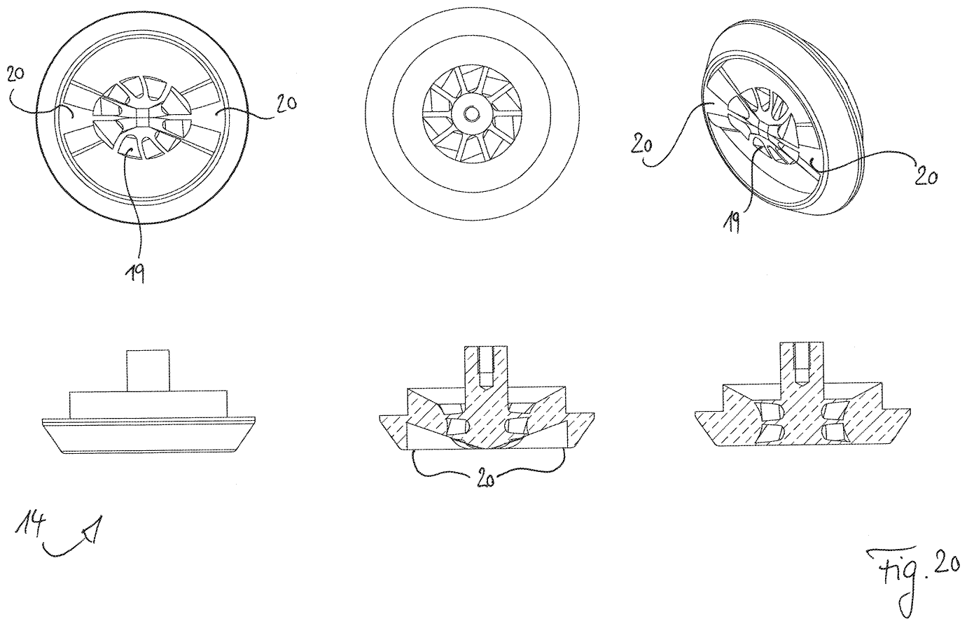

FIGS. 7 to 20 show in each case six views of a wobbler disk 14 according to the invention from FIGS. 1 and 2.

FIGS. 1 and 2 and 4 to 6 show a device 2 according to the invention for applying clay (not illustrated) to a surface 4 for producing a preliminary model 4, as described at the outset. The device 2 has a housing 6 with a connecting port 8 for a clay supply line (not illustrated), specifically a flexible (heated) high-pressure hose (not illustrated), so as to enable movements of the device 2 across the surface 4 (for example by hand, or else by means of a robotic arm) in an ideally free manner. The housing 6 also has a clay dispensing flange opening 12.

In the region of the dispensing opening 12, each of the devices 2 has a disk 14 which is driven by a motor 18 by way of a drive shaft 16. FIGS. 3 and 7 to 20 show the respective disks individually, in each case in six views.

According to the invention, the device 2 specifically has a disk which sits in a clay-tight manner in the clay dispensing flange opening 12 and is, as indeed mentioned, rotatable and driven by a motor. The disk 14 in the process closes off this flange opening 12—but for dispensing the clay has (at least one) dispensing opening 19 through which the clay supplied to the device 2 can exit.

On the external side, moreover, the disk 14 has at least one elevation 20.

The elevation 20 is a massaging bead, so to speak, i.e. a “wobbler”, which on account of its circular movements serves to massage the clay onto the surface 4 (and into the surface)—specifically when the surface 4 is already composed of clay, in particular, for instance because a layer of clay has already been applied.

FIGS. 3 and 7 to 20 show that in each of the figures two elevations 21
are disposed eccentrically on the disk 14; and/or
extend along the radial periphery of the disk 14; and/or
conjointly with a region of the external side or the entire external side of the disk 14, form a consistent surface; and/or
have an edge 21 which also extends radially.

To this end, it is also particularly preferable that the (at least one) dispensing opening 19 in the disk 14
is an elongate bore which extends in the shape of a circular segment and concentrically in the disk; and/or
a plurality of dispensing openings 19 are distributed uniformly on a circumference about the rotation axis 16 of the disk 14.

In order to further facilitate these functions, in particular for application to flat or convex surfaces 4, the flange opening 12 first has a periphery 22 which lies in a plane. The disk 14 according to FIG. 1 does not protrude from the flange opening 12—according to FIG. 2, in contrast, the wobbler 20 does protrude from the flange opening 12.

The housing 6 in FIGS. 1 and 2 is adjustable and variable between these configurations. To this end, the region of the periphery 22 of the dispensing opening 12, by way of a sleeve 24, which matches in form-fitting manner, is designed to be removed (and replaced again) and be substituted by another sleeve 24. By attaching the one sleeve 24 (FIG. 1), the opening periphery 22 of the sleeve 24 can be repositioned farther out of the housing 6, toward the front (toward the left in the figure), so that the elevation, i.e. the wobbler 20, also disappears in the flange opening 12. If a shorter sleeve 24 according to FIG. 2 is used, the massaging bead 20 of the same disk 14 will project from the flange opening 12.

Or else, by replacing the sleeve 24 (according to FIGS. 4 to 6), the opening periphery 26 of the sleeve 24 can also be adapted in a clay-tight manner (and/or functionally designed in the manner of the opening periphery 22 as described) to the different respective disks 14 used in FIGS. 4 to 6.

A mixer 34 and/or propeller or impeller 32 (in particular two impellers 32, preferably having blades inclined in opposite directions—or even a plurality of impellers—in particular axially spaced apart from one another) can also be disposed in the device 2, in particular in the region of the dispensing line 30, so as to in particular additionally homogenize and mix the clay. These can likewise be rotationally driven by the motor 18. To this end, the impellers 32 in this instance preferably sit on a drive shaft 16, conjointly with the disk 14.

Alternatively however, the impellers 32 and their mounting can also be designed in such a way that the impellers are not actively driven by the drive 18, but are either held on the tubular wall 30, thus serving as stationary impellers, or are mounted so as to freely rotate on the shaft 16, for example in a “floating” manner with a through bore, so that said impellers, depending on the inclination of their blades, are driven in a rotating direction by the clay flowing through (not shown), and in this way additionally homogenize and mix the clay. The same applies in an analogous manner to the mixer 34.

### LIST OF REFERENCE SIGNS

Device 2
Surface, preliminary model 4
Housing 6
Connecting port 8
Clay-dispensing flange opening 12
Disk 14
Drive shaft 16
Motor 18
Clay-dispensing opening 19
Elevation, massaging bead, wobbler 20
Edge 21
Periphery 22 of the flange opening 12
Sleeve 24
Clay-dispensing line 30
Propeller or impeller 32
Mixer 34

1-8. (canceled)

9. A device for applying clay to a surface, in particular for producing automotive design models, comprising: a housing with a connecting port for a clay supply line, and with a clay-dispensing phalange opening; a motor; and a disk that sits in a clay-tight and rotatable manner in the clay-dispensing flange opening so as to be driven by the motor, wherein the disc has a clay-dispensing opening and otherwise closes off the flange opening, and wherein the disk has an elevation on an external side.

10. The device according to claim 9, wherein the elevation is disposed eccentrically on the disk.

11. The device according to claim 9, wherein the elevation extends along a radial periphery of the disk.

12. The device according to claim 9, wherein the elevation, conjointly with a region of the external side or the entire external side of the disk, forms a consistent surface.

13. The device according to claim 11, wherein the elevation has an edge that also extends radially.

14. The device according to claim 9, wherein the clay-dispensing opening is at least one elongate bore that extends in a shape of a circular segment and concentrically in the disk.

15. The device according to claim 9, comprising a plurality of the dispensing opening distributed uniformly on a circumference about a rotation axis of the disk.

16. The device according to claim 9, further comprising a clay dispensing line and at least one mixer and/or impeller are/is disposed in the dispensing line so that the clay is able to pass therethrough.
